(19) United States
(12) Patent Application Publication
(10) Pub. No.: US 2014/0048667 A1
(43) Pub. Date: Feb. 20, 2014

(54) MOUNTING DEVICE FOR SECURING ELECTRONICS EQUIPMENT IN A VEHICLE

(71) Applicant: Wachendorff Elektronik GmbH & Co., KG, Geisenheim (DE)

(72) Inventors: Dirk Ziesen, Lorch (DE); Peter Wachendorff, Lorch (DE)

(73) Assignee: Wachendorff Elektronik GmbH & Co., KG, Geisenheim (DE)

(21) Appl. No.: 13/966,935

(22) Filed: Aug. 14, 2013

(30) Foreign Application Priority Data
Aug. 16, 2012 (DE) 102012107516.6

(51) Int. Cl. F16M 13/02

(52) U.S. Cl. CPC F16M 13/022
USPC 248/288.11

(57) ABSTRACT

A mounting device for securing electronic equipment in a vehicle includes a holding fixture for holding the electronic equipment and a supporting arm, wherein the holding fixture on a first end of the supporting arm is supported pivotably on the supporting arm and wherein the supporting arm can be connected to the vehicle on a second end, wherein the supporting arm includes an interior which can be accessed from the outside by a longitudinal slot, and the interior and the longitudinal slot extend across more than half of a length of the supporting arm, preferably across the entire length of the supporting arm, lire supporting arm has a spherical cap-shaped form on its first end, on which a matching spherical cap-shaped wall section of the holding fixture can be secured by clamping. The supporting arm includes a threaded section in the area of the first end, so that the holding fixture using a spherical, cap-shaped clamping element with a matching threaded section can be secured on the spherical cap-shaped form of the supporting arm by clamping.

The invention relates to a mounting device for securing electronic equipment in a vehicle with a holding fixture for supporting the electronic equipment and with a supporting arm, wherein the holding fixture is pivoted on a first end of the supporting arm relative to the supporting arm and wherein the supporting arm on a second end can be connected to the vehicle,

Multiple indicating instruments or control units in a vehicle are normally arranged within the field, of vision and/or the operating range of a driver. The indicating instruments and control units can he analog and mechanical indicating instruments. Modern control units frequently contain several control elements in addition to an indicating instrument for controlling, actuating and monitoring the individual functions and characteristics of the vehicle or a component associated therewith. For this purpose, the indicating instruments and control units should be arranged optimally within the field of vision of the driver and be able to be operated easily, if needed; on the other hand the driver's view of the environment should be affected or restricted as little as possible.

The usual practice is to mount electronic equipment with a mounting device on top of or against the instrument panel or on the interior paneling of a vehicle. In this case, an individual adaptation of the instrument panel or of the interior paneling is not necessary. The electronic equipment can be replaced easily and cost-effectively. The vehicle manufacturer can resort to using electronic equipment of a third-party vendor cost-effectively and secure the electronic, equipment in the vehicle using a suitable mounting device, irrespective of the styling and design of the vehicle interior.

Such mounting devices normally have a holding fixture for accommodating -the electronic equipment and a supporting arm, by means of which the holding fixture can be secured on a mechanical part in the vehicle. Such mounting device can subsequently be secured in a bore or onto a form that is adapted thereto, for example. While suction, cup fixtures are rather suited for mobile low-weight electronic equipment and tor a mounting device with a short supporting arm, larger indicating instruments or control units can also be secured onto a supporting arm that is bolted onto the vehicle.

However, with these types of mounting devices it is perceived to be irritating that the connection cables for connecting the electronic equipment with other vehicle components frequently run unrestrained next to the mounting device. When using such type of mounting devices it is usually found to be troublesome that the connection cables for connecting the electronic equipment to other vehicle components frequently run untidily and loose next to the mounting device. Having the connection cables lying around loose is perceived as an aesthetic impairment of the vehicle interior. Loose exposed connection cables can hamper driver operation and may present a safety risk while using the vehicle, in particular if the supporting arm is long. To run the connection cables so that they are covered and do not present a hazard normally requires significant expense in structural design and requires adaptation of the instrument panel or of the mechanical component of the vehicle on which the electronic equipment is to be secured.

Vehicle manufacturers frequently use and install prefabricated cable trees with connectors in vehicles, so that the electronic equipment must be connected with the connectors that are already provided on the cable for the electronic equipment while or after it is being arranged in the vehicle. Laying these cable sections, the ends of which are provided with connectors for sections of the connection cables for the electronic equipment through narrow pipes or cable conduits, is frequently difficult or almost impossible, since the connectors are normally significantly larger than the respective cable diameter and do not fit easily through the pipes or cable conduits.

It is desirable to develop a mounting device of the species mentioned at the outset such that electronic equipment can be secured in the vehicle without major aesthetic impairment and without creating a noteworthy safety risk.

According to an aspect of the invention, a supporting arm has a cavity which can be accessed from the outside via a longitudinal slot and that the cavity and the longitudinal slot extend for more than half of a length of the supporting arm. This makes it possible to insert one or even several connection cables along the side of the supporting arm from the outside into the cavity inside the supporting arm. By running the connection cables along a large area of the supporting arm in a cavity of the supporting arm, they are not visible from the outside and obscure neither the field of vision nor the field of activity of the driver or of any other persons present within the vehicle. The longitudinal slot can have a comparatively small width that must just be a little bit larger than the biggest diameter of a connection cable to the electronic equipment. If the electronic equipment is connected with multiple connection cables, the connection cables can be inserted though the longitudinal slot sequentially into the cavity inside the supporting arm, where they can be arranged and/or installed.

Using clamp rings, which are also slotted and which can be pushed subsequently over the longitudinal slot in the supporting arm or be fixed there by clamping, the connection cables can be fixed in the axial direction and/or the inlet and outlet areas for connection cables can be predetermined. This will prevent any subsequent unintended dropping out or emergence of a connection cable from, the cavity.

It is preferably provided that the cavity and the longitudinal slot extend essentially along the entire length of the supporting arm. If the second end of the supporting arm has a continuous longitudinal slot, the connection cables can be brought out through the same bore in an instrument panel or a mechanical component of the vehicle in which the supporting arm can be secured with Its second end. The connection cables can then be routed through the slotted supporting arm up to the electronic equipment secured on the supporting arm. so that they are hidden from the outside. It is not necessary to provide a further bore or opening in addition to the mounting bore in the instrument panel through which the connection cables are brought out of the instrument panel away from the mounting bore.

Since the connection cables do not have to be routed or pulled through the supporting arm in the axial direction and for the same reason also any potential connectors that may be on the ends of the connection cables do not have to be routed through the supporting arm, the diameter of the supporting arm must be adapted exclusively to the required space for the connection cables. It is therefore not necessary to size the cross-sectional area of the supporting arm to account for the connectors which are frequently significantly larger, so that the supporting arm with the longitudinal slot for the lateral insertion of the connection cables can be designed significantly slimmer and with a cross-sectional area that is considerably less than a hollow supporting arm, in which the connection cables have to be pulled through the interior of the supporting arm in the axial direction.

It is advantageously provided that the supporting arm has a threaded section on its second end. This threaded section can be used for fixing the supporting arm in a bore with a matching threaded section. Such bore can be created in an instrument panel or in a mechanical component of a vehicle subsequently without major expense. It is not necessary for the instrument panel to be customized.

If the connection cables are also brought out through this bore from the instrument panel, a mounting device that has a neat appearance can be installed quickly and easily and such that the connection cables can be integrated in the mounting device afterwards so that the mounting device can be secured in the vehicle.

According to a particularly advantageous embodiment of the inventive idea it is provided that the supporting arm has a spherical cap-shaped form on its first end, on which a matching spherical cap-shaped wall section of the holding fixture can be secured by clamping. Such pivoting devices, in which the spherical cap-shaped wall sections are brought into contact and can be secured to each other by clamping are particularly suitable for an articulated mechanism that can be pivoted polydimensionally to facilitate a swivel range up to 20° or 30°. It can be necessary or useful, if the electronic equipment is aligned adapted to the size and the seating position of the user or, for example, if the electronic equipment is to be swiveled due to the current position of the sun to prevent sunlight from directly impinging on an indicating instrument or on the equipment surface, and light reflections occur that are annoying for the user, making it difficult to read the displayed information or operate the electronic equipment. Experience has shown that a swivel range of approximately 20° to 30° is frequently sufficient to align and adapt the electronic equipment satisfactorily for the user in most situations.

Because of the adjacent spherical cap-shaped wall sections, a large contact surface and therefore a high mechanical stability of the holding fixture can be ensured that is locked into position on the supporting arm at a predetermined angle. The adjustment mid resetting of the electronic equipment into a changed alignment is possible easily and with minimum manipulation.

Preferably it is provided that the supporting arm has a threaded section in the area of the first end and that the holding fixture can be secured on the spherical cap-shaped form of the supporting arm with a spherical cap-shaped clamping element that has a matching threaded section. Using a spherical cap-shaped clamping element which can be repositioned towards or away from the spherical cap-shaped form of the supporting arm by means of screwing motions, the spherical cap-shaped wall section of the holding fixture located in-between can either be clamped or be released in a simple manner. For this purpose, the clamping element can be easily repositioned simply with a brief rotational movement, so that the holding fixture can be repositioned and realigned against any remaining clamping force, without having to completely release the clamping connection so that the holding fixture could tilt unimpeded into an end position.

To simplify the handling of the mounting device and in particular adjusting and locking the holding fixture relative to the supporting arm, it is provided that, an elastic clamping body is arranged between the spherical cap-shaped form of the supporting arm and the spherical cap-shaped wall section. The elastic clamping body can consist of or comprise multiple molded parts made of an elastic material, such as rubber. The elastic clamping body and/or the multiple molded parts can be arranged in matching recesses in the spherical cap-shaped form of the supporting arm or in the spherical cap-shaped wall section and be secured with, adhesive, for example.

It is also possible that the elastic clamping body is a slotted sealing ring. The sealing ring can be positioned and fixed in a peripheral groove in the spherical cap-shaped form of the supporting arm or in the spherical cap-shaped wall section of the holding fixture.

It is obviously also conceivable that the elastic clamping body is arranged between the spherical cap-shaped wall section of the holding fixture and a likewise optional spherical cap-shaped clamping element.

The use of an elastic clamping body can have a positive effect on the clamping action. In addition to the clamping effect, static friction can be exerted on the pivoted holding fixture by means of the elastic clamping body to facilitate the release and realignment of the holding fixture relative to the supporting arm.

According to an advantageous embodiment of the inventive idea, it is provided that the holding fixture has a bushing for connection cables. In this manner it is possible to install the required connection cables for the electronic equipment not only in the interior of the supporting arm in the area of the supporting arm, but route them directly from the interior of the supporting arm through the bushing in the holding fixture to the electronic equipment. As a result, the connection cables can also be routed and/or installed through the supporting arm and the holding fixture up to the electronic equipment so that they are protected and cannot be seen from the outside and be connected to the electronic equipment there.

To facilitate subsequent assembly of the mounting device, it is provided that the holding fixture comprises a longitudinal slot. The connection cables can then be inserted through this longitudinal slot from the outside laterally into the holding fixture. With regard to making the installation as easy as possible, the connection cables can be connected with the electronic equipment either beforehand or subsequently. In this context it is practical if the longitudinal slot extends up to the bushing developed in the holding fixture for the connection cables. The holding fixture can be arranged so that its longitudinal slot is aligned with the longitudinal slot in the supporting arm and be already connected with the supporting arm prior to the subsequent insertion of the connection cables through the longitudinal slot into the interior of the supporting arm, and/or in the bushing in the holding fixture and the mounting device is connected with the second end of the supporting arm with the vehicle or the electronic equipment is secured on the holding fixture.

If the holding fixture is twisted prior to securing and aligning the electronic equipment, so that the longitudinal slot in the holding .fixture is no longer aligned with the longitudinal slot in the supporting arm, prevents that a connection cable running on the inside can drop or hang out from the inside in this area.

In order to also shield connection cables against the environment in this transition region from the holding fix tare to electronic equipment connected with it, and to give it a neat appearance, it is provided that the holding fixture comprises a retention device for the electronic equipment, and a cover for connection cables. The retention device can comprise an L-shaped or C-shaped retention element, for example, in which an indicating instrument or a plate or tablet shaped control unit can. be inserted and secured. For this purpose, it is useful if the retaining element also surrounds that area of the electronic equipment in which the connection cables can be connected with the electronic equipment by means of plug-in connectors. This area can be covered by a shield or a detachable cover, so that the connection cables including the plug-in connectors cannot be seen and are not accessible from the outside.

### BRIEF DESCRIPTION Of THE DRAWINGS

In the following, embodiments of the inventive idea are explained in. detail, which are illustrated in the drawing, as follows:

FIG. 1 is a perspective view of a mounting device with a supporting arm and a holding fixture connected with the holding arm so that it can be pivoted,

FIG. 2 is a cross-sectional view of the mounting device illustrated in FIG. 1,

FIG. 3 is a cross-sectional view of a differently developed mounting device,

FIG. 4 is a cross-sectional view through a holding fixture, in which an electronic control unit is secured and connected with connection cables, and

FIG. 5 is a cross-sectional view according to FIG. 4, wherein the holding fixture and the pivotable supporting arm connected with it are developed differently.

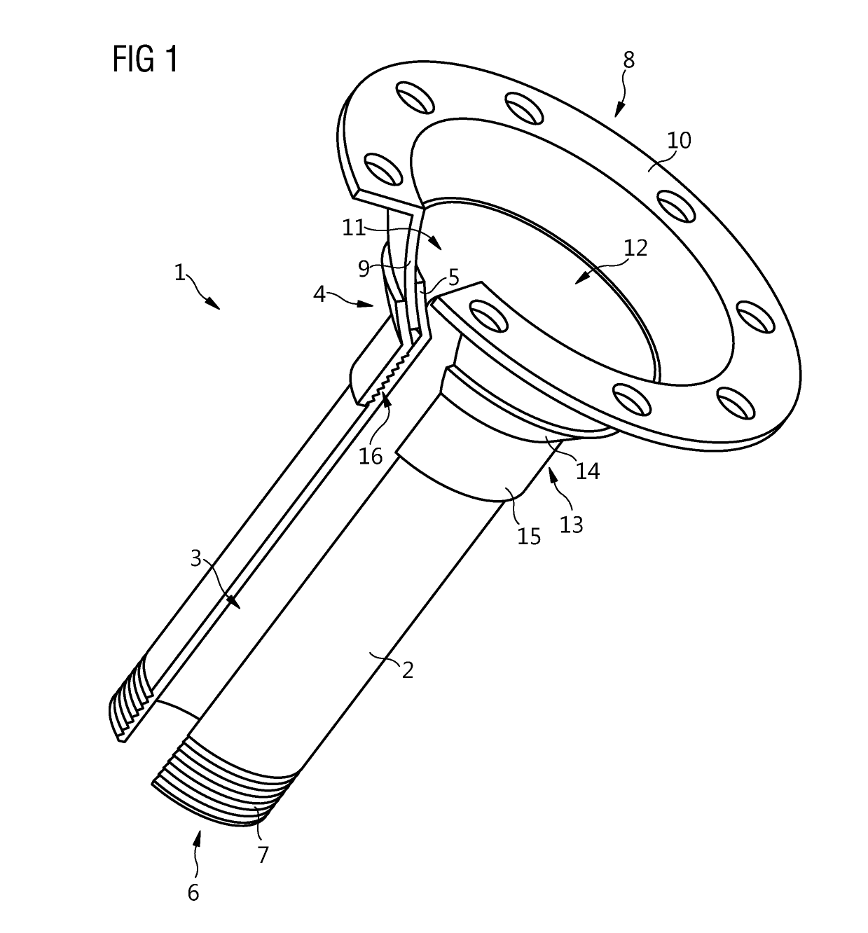

### DETAILED DESCRIPTION

A mounting device 1 shown as an example in FIG, 1 and 2 comprises a hollow cylindrical supporting arm 2 with a longitudinal slot 3 extending along the entire length of the supporting arm. The supporting arm 2 has a spherical cap-shaped form 5 on a first end 4. On a second end 6, the supporting arm 2 has a threaded section 7, with which the supporting arm 2 can be secured in a bore or in a matching receptacle therein, for example in an instrument panel or in a mechanical component of a vehicle.

A holding fixture 8 is arranged in the area of the first end 4 of the supporting arm 2. The holding fixture 8 also comprises a spherical cap-shaped wall section 9, which is matched, to the spherical cap-shaped form 5 of the supporting arm 2, On an end facing away from the supporting arm 2, the holding fixture 8 comprises a mounting flange 10 which protrudes radially to the outside. Electronic equipment can be secured on the mounting flange 10.

Same as the supporting arm 2, the holding fixture 8 also has a longitudinal slot 11 which extends axially and is arranged laterally. The wall section 9 and the mounting flange 10 surround an interior 12 in the holding fixture 8, which can be utilized as a bushing for the connection cables.

With the help of a clamping element 13, the spherical cap-shaped wail section 9 of the holding fixture 8 is pushed against the matching and likewise spherical cap-shaped form 5 of the supporting arm 2. For this purpose, the clamping element 13 also comprises a spherical cap-shaped clamping section 14 and a hollow cylindrical threaded section 15. In the area of the threaded section 15, the clamping element 13 can engage with a matching threaded section 16 on the supporting arm 2 and be positively secured on the supporting arm 2 in the area of the first end 4. The clamping element 13 presses the spherical cap-shaped, wall section 9 against the spherical cap-shaped form 5 of the supporting arm 2 with the clamping section 14, and secures the holding fixture 8 clamping on the spherical cap-shaped form 5 of the supporting arm 2 aligned as predetermined by a user. To adjust the alignment of the holding fixture 8, it is merely necessary to remove the clamping element 13 from the spherical cap-shaped form 5 with a screwing motion, so that the wall section 9 of the holding fixture 8 located in-between is loosely inserted between the spherical cap-shaped form 5 of the supporting arm 2 and the clamping section 14 of the clamping element 13, and can be shifted easily. To lock the holding fixture 8 in a desired alignment, the clamping element 13 must be shifted in the direction of the spherical cap-shaped form 5 with a screwing motion and/or with only one manual action in order to secure the wall section 9 clamping again.

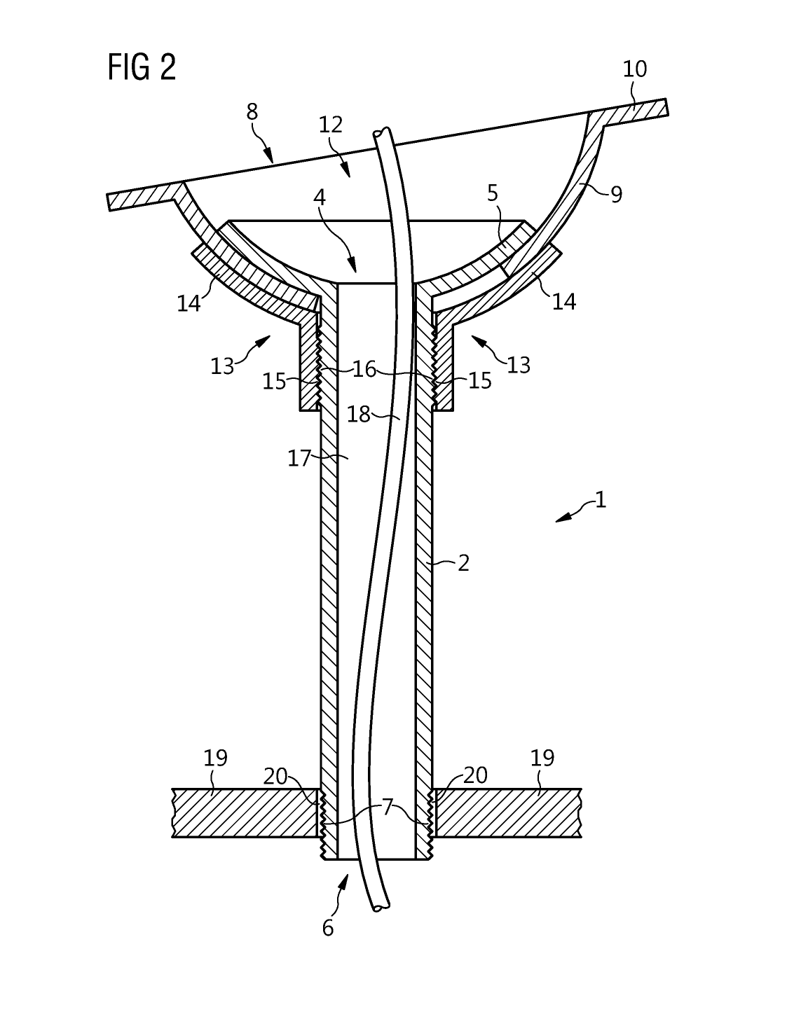

A connection cable 18 runs within the interior 17 of the supporting arm 2 that is particularly clearly represented in FIG. 2, which enters into the supporting arm 2 on the second end 6 and exits the supporting arm 2 on the first end 4 through the interior 12 of the holding fixture 8. The connection cable can be inserted laterally into the supporting arm 2 and/or into the holding fixture 8 through the longitudinal slots 3 and 11 arranged on the side. To secure the mounting device 1 on an Instrument panel 19, the connection cable 18 must merely be inserted into the mounting device 1 and subsequently the supporting arm 2 with its threaded section 7 on its second end 6 be screwed into a matching threaded section 20 in the instrument panel 19 and be screwed down.

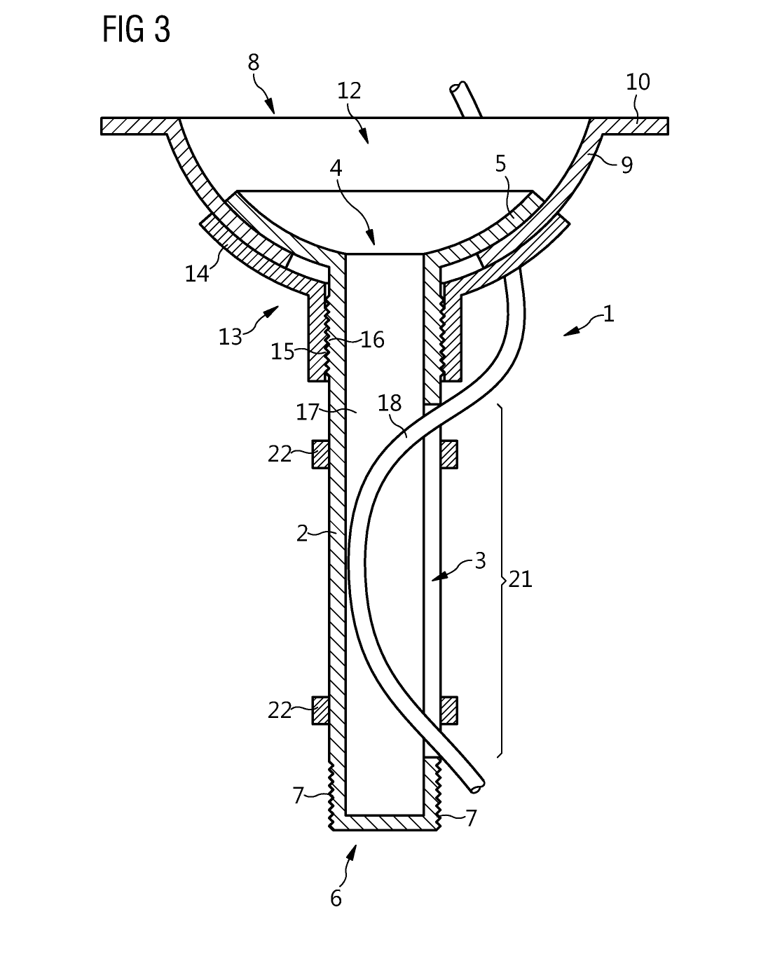

In the example of the embodiment illustrated in FIG. 3, the longitudinal slot 3 of the supporting arm 2 does not extend across the entire length of the supporting arm 2, but merely across a center section 21 of the supporting arm 2. In this development of the supporting arm 2, the connection cable 18 can be inserted laterally into the interior 17 and be brought out again from the interior 17 of the supporting arm 2 below the clamping element 13. The connection cable 18 in this center section 21 runs in the interior 17 of the supporting arm 2, protected against undesirable exposure and from being accessed by a user. The connection cable 18 in the area of an entry and an exit from the interior 17 is secured by clamping rings 22, which are subsequently pushed onto the supporting arm 2 from the outside and which can be shifted in the axial direction, which prevents the connection cable 18 from dropping out or being pulled out from the interior 17 of the supporting arm 2.

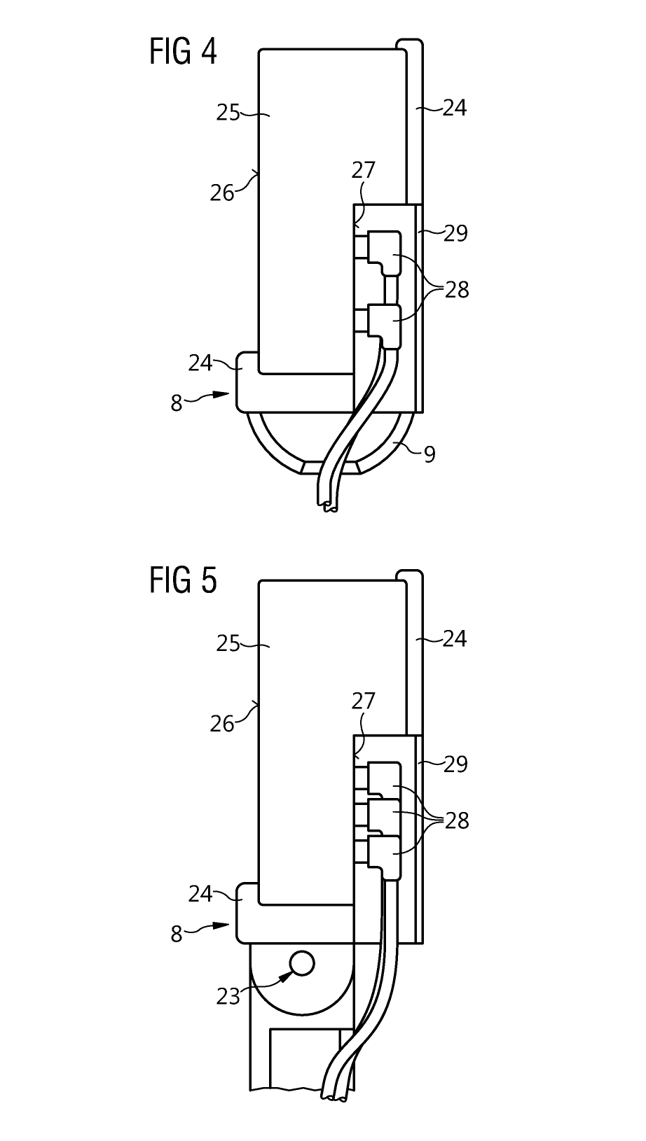

FIGS. 4 and 5 illustrates examples of two different developments of the holding fixture 8. Whereas the holding fixture 8 illustrated in FIG. 4 also comprises the spherical cap-shaped wall section 9 which is described in the preceding embodiments, in the embodiment illustrated, in FIG. 5, a pivoting mechanism 23 is provided instead that can be swiveled about a horizontal axis. In both cases, the holding fixture 8 comprises an approximately L-shaped retention element 24, holding a rectangular control unit 25. The control unit 25 has a display device on its front side 26 that is facing towards a viewer. On one rear side 27, multiple connection cables 18 can be connected with the control unit 25 using suitable plug-in connectors 28. A flush-mounted cover 29 covers the plug-in connection 28 connected with the control unit 25 and protects this area against exposure and access by a user.

1. A mounting device for securing electronic equipment in a vehicle with a holding fixture for holding the electronic equipment and with a supporting arm, wherein the holding fixture on a first end of the supporting arm is supported pivotably on the supporting arm and wherein the supporting arm can be connected to the vehicle on a second end, wherein the supporting arm comprises an interior which can be accessed by means of a longitudinal slot, and that the interior and the longitudinal slot extend across more than half of a length of the supporting arm.

2. The mounting device according to claim 1, wherein the interior and the longitudinal slot extend essentially across the entire length of the supporting arm.

3. The mounting device according to claim 1, wherein the supporting arm has a threaded section on its second end.

4. The mounting device according to claim 1, wherein the supporting arm has a spherical cap-shaped form on its first end, on which a matching spherical cap-shaped wall section of the holding fixture can be secured by clamping.

5. The mounting device according to claim 4, wherein the supporting arm comprises a threaded section in the area of the first end and that the holding fixture using a spherical cap-shaped clamping element with a matching threaded section can be secured on the spherical cap-shaped form of the supporting arm by clamping.

6. The mounting device according to claim 4, wherein an elastic clamping body is arranged between the spherical cap-shaped form of the supporting arm and the spherical cap-shaped wall section of the holding fixture.

7. The mounting device according to claim 6, wherein the elastic clamping body is a slotted sealing ring.

8. The mounting device according to claim 1, wherein the holding fixture comprises a bushing for connection cables.

9. The mounting device according to claim 8, wherein the holding fixture comprises a longitudinal slot.

10. The mounting device according to claim 1, wherein the holding fixture comprises a retention device for the electronic equipment and a cover for connection cables.
